(19) United States
(12) Patent Application Publication
(10) Pub. No.: US 2015/0303551 A1
(43) Pub. Date: Oct. 22, 2015

(54) COMMUNICATION DEVICE ANTENNA

(71) Applicant: KING SLIDE TECHNOLOGY CO.,LTD., Kaohsiung City (TW)

(72) Inventors: Hsin-Cheng Su, Kaohsiung City (TW); Chun-Ta Liu, Kaohsiung City (TW); Shu-Chen Lin, Kaohsiung City (TW)

(73) Assignee: KING SLIDE TECHNOLOGY CO.,LTD., Kaohsiung City (TW)

(21) Appl. No.: 14/253,875

(22) Filed: Apr. 16, 2014

(51) Int. Cl. H01Q 1/24

(52) U.S. Cl. CPC H01Q 1/243

(57) ABSTRACT

The present invention relates to a communication device antenna, including a metal housing, an antenna and a conductor. The metal housing has a first lateral side and a second lateral side. The antenna includes a first metal part, a second metal part, a third metal part and a fourth metal part. The third metal part is extended and connected between the first metal part and the second metal part, and the third metal part is located adjacent to the first lateral side of the metal housing. The fourth metal part is connected to a ground point, and the fourth metal part is connected to the first metal part and the metal housing. The conductor is located adjacent to the second metal part of the antenna. A coupling gap is defined between the conductor and the second metal part. The conductor is connected to a signal feed point.

### BACKGROUND OF THE INVENTION

1. Field of the Invention

The present invention relates to a communication device antenna, and more particularly, to a metal housing being utilized as an antenna of a communication device, for emitting and receiving radio signals of the communication device.

2. Description of the Prior Art

During product development processes of conventional communication devices, such as mobile communication products, plastic housings are mainly used by manufacturers due to cost concerns, in order to maintain basic radiation characteristics of an antenna. However, a trend of metal housing is currently brought by Apple iPhones and Macbooks. Since the metal housing has light weight, good heat dissipation, high strength, high impact resistance, good looking, anti-electromagnetic and recyclable characteristics, the metal housing is getting more and more popular. Therefore, the metal housings are mainly used in development of new generations of the mobile communication products. For example, U.S. Pat. No. 8,054,231 B2 disclosed by Ahn et al. teaches a metal case having a slot, which can be used as a slot antenna of a mobile device. But the slot may obviously ruin appearance of the metal case, and the slot needs to be arranged at a position corresponding to a specific area of the metal case. Therefore, it is important to design a proper antenna to allow electromagnetic waves to penetrate the metal case for achieving communication purposes without obviously ruining the appearance of the metal case.

### SUMMARY OF THE INVENTION

It is therefore an objective of the claimed invention to provide a communication device antenna in order to utilize a metal housing as an antenna, for emitting and receiving radio signals of a communication device.

According to an embodiment of the present invention, a communication device antenna comprises a metal housing, a signal feed point, a ground point, an antenna and a conductor. The metal housing has a first lateral side, a second lateral side corresponding to the first lateral side, and a connection side extended and connected between the first lateral side and the second lateral side. The antenna comprises a first metal part, a second metal part, a third metal part and a fourth metal part. The first metal part, the second metal part, the third metal part and the fourth metal part together form a loop antenna trace. The antenna is separated from the metal housing by an opening. The third metal part is extended and connected between the first metal part and the second metal part, and the third metal part is located adjacent to the first lateral side of the metal housing. The fourth metal part is connected to the ground point, the first metal part and the metal housing. The conductor is located adjacent to the second metal part of the antenna. A coupling gap is defined between the conductor and the second metal part. The conductor is connected to the signal feed point.

Preferably, the first metal part of the antenna is a straight section, the second metal part of the antenna is a straight section, and the first metal part is longer than the second metal part.

Preferably, the first metal part of the antenna is substantially arranged along the adjacent connection side of the metal housing.

Preferably, the third metal part of the antenna is substantially extended and connected between the first metal part and the second metal part perpendicularly.

Preferably, the opening comprises a first slit and a second slit, the second slit is substantially perpendicular to the first slit, the first slit is formed straight along the adjacent connection side of the metal housing, and the second slit is located adjacent to the second lateral side of the metal housing.

Preferably, the conductor has a first conductive wire section and a second conductive wire section, the second conductive wire section is substantially connected to the first conductive wire section perpendicularly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing arrangement of a communication device according to an embodiment of the present invention.

FIG. 2 is a diagram showing antenna arrangement of the communication device according to the embodiment of the present invention.

FIG. 3 is an enlarged view of an area A in FIG. 2.

FIG. 4 is an enlarged view of an area B in FIG. 2.

### DETAILED DESCRIPTION

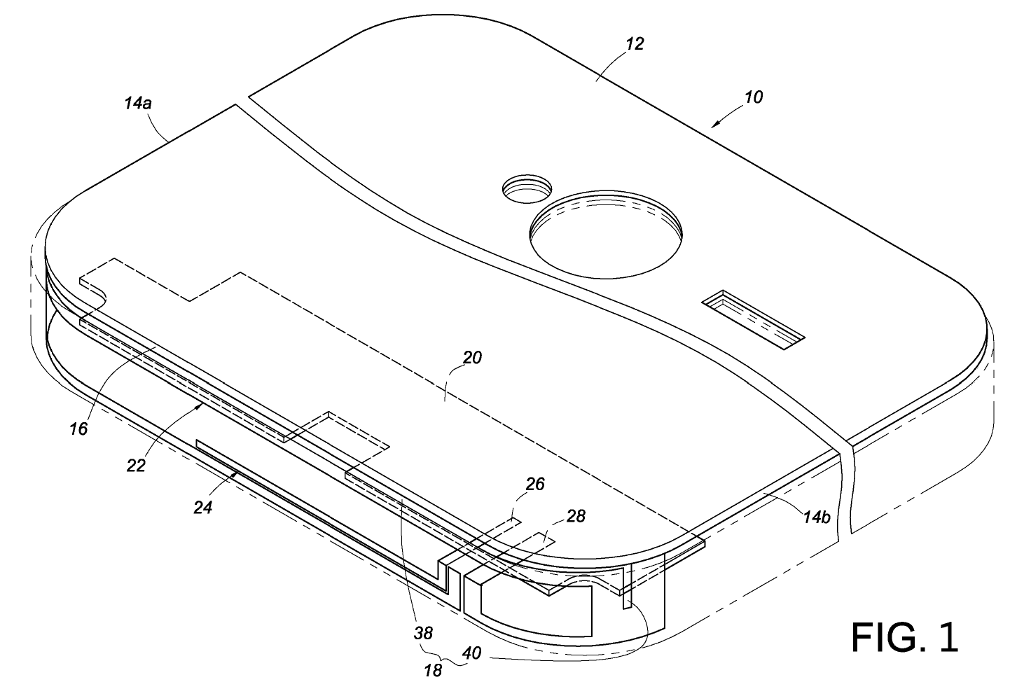

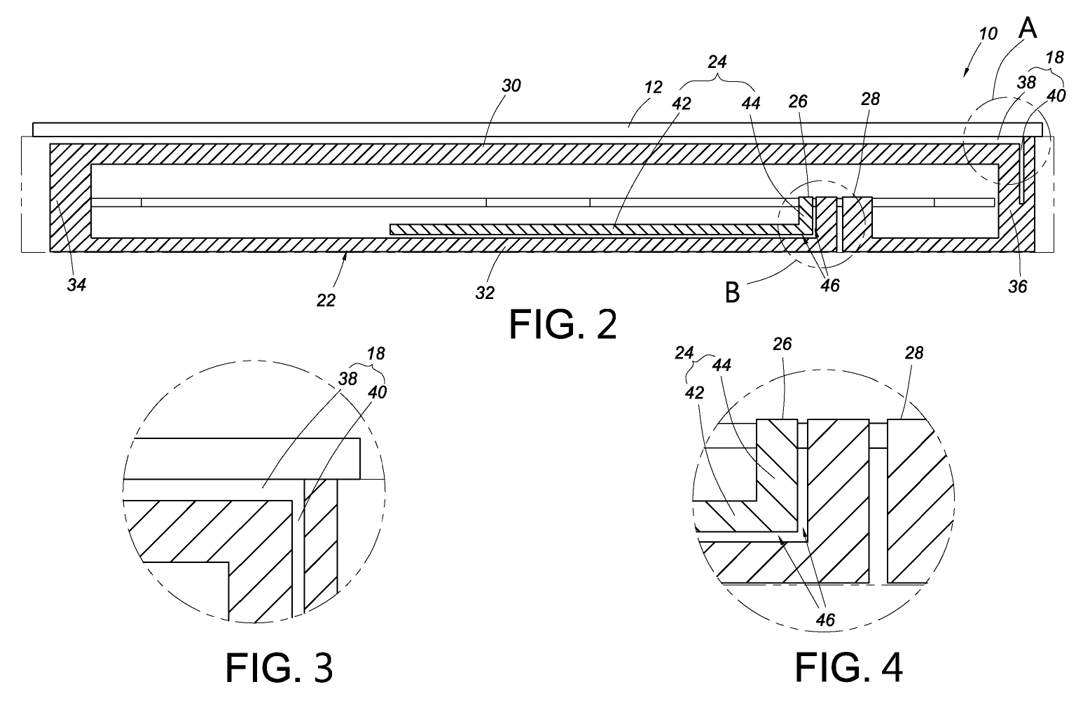

FIG. 1 to FIG. 4 are diagrams showing a communication device 10 having a metal housing 12 according to an embodiment of the present invention. The metal housing 12 has a first lateral side 14a, a second lateral side 14b located at a position corresponding to the first lateral side 14a, and a connection side 16 extended and connected between the first lateral side 14a and the second lateral side 14b.

Antenna arrangement of the communication device 10 comprises at least a printed circuit board 20, an antenna 22 and a conductor 24, wherein the printed circuit board 20 comprises a signal feed point 26 and a ground point 28. Please note that the printed circuit board 20 can be arranged in other size relative to the communication device 10. In other words, the size of the printed circuit board 20 is not limited by the figures.

The antenna 22 comprises a first metal part 30, a second metal part 32, a third metal part 34 and a fourth metal part 36.

The first metal part 30 of the antenna 22 is a straight section, the second metal part 32 of the antenna 22 is also a straight section, and the first metal part 30 is longer than the second metal part 32. In a preferred embodiment, the first metal part 30 of the antenna 22 is substantially arranged along the adjacent connection side 16 of the metal housing 12.

The third metal part 34 of the antenna 22 is extended and connected between the first metal part 30 and the second metal part 32, and the third metal part 34 is located adjacent to the first lateral side 14a of the metal housing 12.

The fourth metal part 36 of the antenna 22 is connected to the ground point 28 of the printed circuit board 20, and the fourth metal part 36 is connected to the first metal part 30 and the metal housing 12.

In a preferred embodiment, an opening 18 is formed and located between the metal housing 12 and the antenna 22, more particularly, the antenna 22 is separated from the metal housing 12 by the opening 18, such that the antenna 22 can operate in a certain mode. The opening 18 further comprises a first slit 38 and a second slit 40 substantially perpendicular to the first slit 38, wherein the first slit 38 is formed straight along the adjacent connection side 16 of the metal housing 12, and the second slit 40 is located adjacent to the second lateral side 14b of the metal housing 12. In a preferred embodiment, the first slit 38 and the second slit 40 together form an L-shaped opening. Please note that the opening 18 is not limited by the shape and arrangement disclosed in the embodiment of the present invention. In addition, a corresponding frequency of the antenna 22 can be adjusted by determining a total length of the opening 18, and this technique is well known in the prior art, thus no further explanation is provided.

The conductor 24 is located adjacent to the second metal part 32 of the antenna 22, and the conductor 24 is connected to the signal feed point 26 of the printed circuit board 20. In a preferred embodiment, the conductor 24 has a first conductive wire section 42 and a second conductive wire section 44. The second conductive wire section 44 is substantially connected to the first conductive wire section 42 perpendicularly. More particularly, a coupling gap, which is approximate to an L-shaped gap, is defined between the first conductive wire section 42 and the second conductive wire section 44 of the conductor 24 and the second metal part 32 of the antenna 22. Please note that the first conductive wire section 42 and the second conductive wire section 44 of the conductor 24 are not limited to be connected with each other perpendicularly, the first conductive wire section 42 and the second conductive wire section 44 of the conductor 24 can be connected with each other non-perpendicularly.

According to the above arrangement, when the communication device 10 is turned on, power at the signal feed point 26 of the printed circuit board 20 is fed into the conductor 24, and the power is further coupled to the second metal part 32 of the antenna 22 through the coupling gap 46, such that the first metal part 30, the second metal part 32, the third metal part 34 and the fourth metal part 36 of the antenna 22 together form an approximate circular path (a loop antenna trace) . Since the fourth metal part 36 of the antenna 22 is connected to the metal housing 12, the metal housing 12 can work as a radiation unit, for transmitting and receiving radio signals of the communication device 10.

According to the above illustration, efficacies and advantages of the present invention are listed as follows:
a. appearance of the metal housing is not obviously ruined, and in contrast to the prior art, the metal housing has better appearance; and
b. the antenna is arranged at an edge of the metal housing, and in contrast to the prior art, the antenna occupies less space.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device antenna, comprising:
a metal housing having a first lateral side, a second lateral side corresponding to the first lateral side, and a connection side extended and connected between the first lateral side and the second lateral side;
a signal feed point;
a ground point;
an antenna comprising:
a first metal part;
a second metal part;
a third metal part extended and connected between the first metal part and the second metal part, and located adjacent to the first lateral side of the metal housing; and
a fourth metal part connected to the ground point, the first metal part and the metal housing, wherein the first metal part, the second metal part, the third metal part and the fourth metal part together forma loop antenna trace, and the antenna is separated from the metal housing by an opening; and
a conductor located adjacent to the second metal part of the antenna and connected to the signal feed point, wherein a coupling gap is defined between the conductor and the second metal part.

2. The communication device antenna of claim 1, wherein the first metal part of the antenna is a straight section, the second metal part of the antenna is a straight section, and the first metal part is longer than the second metal part.

3. The communication device antenna of claim 1, wherein the first metal part of the antenna is substantially arranged along the adjacent connection side of the metal housing.

4. The communication device antenna of claim 1, wherein the third metal part of the antenna is substantially extended and connected between the first metal part and the second metal part perpendicularly.

5. The communication device antenna of claim 1, wherein the opening comprises a first slit and a second slit, the second slit is substantially perpendicular to the first slit, the first slit is formed straight along the adjacent connection side of the metal housing, and the second slit is located adjacent to the second lateral side of the metal housing.

6. The communication device antenna of claim 1, wherein the conductor has a first conductive wire section and a second conductive wire section, the second conductive wire section is substantially connected to the first conductive wire section perpendicularly.
